(19) United States
(12) Patent Application Publication
(10) Pub. No.: US 2020/0099505 A1
(43) Pub. Date: Mar. 26, 2020

(54) Methods of Data Multiplexing Using Dual Frequency Asymmetric Time Division Duplexing

(71) Applicant: Phazr, Inc., Allen, TX (US)

(72) Inventor: Farooq Khan, Allen, TX (US)

(21) Appl. No.: 16/140,509

(22) Filed: Sep. 24, 2018

(51) Int. Cl. H04L 5/14; H04L 5/00; H04W 72/04

(52) U.S. Cl. CPC H04L 5/1469; H04B 7/0413; H04W 72/0453; H04L 5/0055

(57) ABSTRACT

A method for wireless communication by using dual frequency asymmetric time division duplex (TDD) includes transmitting first downlink data by a radio base station during a first time division duplex (TDD) downlink time period on a first frequency band and receiving first uplink data by the radio base station during a first time division duplex (TDD) uplink time period on the first frequency band, wherein the first TDD downlink time period is greater than the first TDD uplink time period. The method further includes transmitting second downlink data by the radio base station during a second TDD downlink time period on a second frequency band and receiving second uplink data by the radio base station during a second TDD uplink time period on the second frequency band, wherein the second TDD downlink time period is smaller than the second TDD uplink time period.

### BACKGROUND

The invention relates to wireless communications, and in particular relates to methods of data multiplexing using dual frequency asymmetric time division duplexing.

### DESCRIPTION OF THE RELATED ART

Wireless communication networks are widely deployed to provide various communication services such as voice, video, messaging, packet data, unicast, multicast, broadcast, and the like. Currently, wireless networks are typically operated using one of two popular standards: a wide area network (WAN) standard referred to as The Fourth Generation Long Term Evolution (4G LTE) system; and a local area network (LAN) standard called Wi-Fi. Wi-Fi is generally used indoors as a short-range wireless extension of wired broadband systems, whereas the 4G LTE systems provide wide area long-range connectivity both outdoors and indoors using dedicated infrastructure such as cell towers and backhaul to connect to the Internet.

As more people connect to the Internet, increasingly chat with friends and family, watch and upload videos, listen to streamed music, and indulge in virtual or augmented reality, data traffic continues to grow exponentially. In order to address the continuously growing wireless capacity challenge, the next generation of LAN and WAN systems are relying on higher frequencies referred to as millimeter waves in addition to currently used frequency bands below 7 GHz. The next generation of wireless WAN standard referred to as 5G New Radio (NR) is under development in the Third Generation Partnership Project (3GPP). The 3GPP NR standard supports both sub-7 GHz frequencies as well as millimeter wave bands above 24 GHz. In 3GPP standard, frequency range 1 (FR1) covers frequencies in the 0.4 GHz-6 GHz range. Frequency range 2 (FR2) covers frequencies in the 24.25 GHz-52.6 GHz range. Table 1 provides examples of millimeter wave bands including FR2 bands that may be used for wireless high data-rate communications. Table 2 separately lists examples of FR2 bands in the 3GPP standard. In the millimeter wave bands above 24 GHz, a time division duplexing (TDD) scheme is generally preferred. However, regulations in most parts of the World allow using other duplexing schemes including frequency division duplexing (FDD).

TABLE 1
Examples of millimeter wave bands

| Bands [GHz] | | Frequency [GHz] | Bandwidth [GHz] |
|---|---|---|---|
| 26 | GHz Band | 24.25-27.5 | 3.250 |
| LMDS Band | | 27.5-28.35 | 0.850 |
| | | 29.1-29.25 | 0.150 |
| | | 31-31.3 | 0.300 |
| 32 | GHz Band | 31.8-33.4 | 1.600 |
| 39 | GHz Band | 38.6-40 | 1.400 |
| 37/42 | GHz Bands | 37.0-38.6 | 1.600 |
| | | 42.0-42.5 | 0.500 |
| 47 | GHz | 47.2-48.2 | 1.000 |
| 60 | GHz | 57-64 | 7.000 |
| | | 64-71 | 7.000 |
| 70/80 | GHz | 71-76 | 5.000 |
| | | 81-86 | 5.000 |
| 90 | GHz | 92-94 | 2.900 |
| | | 94.1-95.0 | |
| 95 | GHz | 95-100 | 5.000 |
| 105 | GHz | 102-105 | 7.500 |
| | | 105-109.5 | |
| 112 | GHz | 111.8-114.25 | 2.450 |
| 122 | GHz | 122.25-123 | 0.750 |
| 130 | GHz | 130-134 | 4.000 |
| 140 | GHz | 141-148.5 | 7.500 |
| 150/160 | GHz | 151.5-155.5 | 12.50 |
| | | 155.5-158.5 | |
| | | 158.5-164 | |

TABLE 2
Examples of FR2 bands in 3GPP

| 5G-NR | Uplink (UL) and Downlink | Duplex |
|---|---|---|
| Frequency Band | (DL) operating band | Mode |
| n257 | 26500 MHz-29500 MHz | TDD |
| n258 | 24250 MHz-27500 MHz | TDD |
| n260 | 37000 MHz-40000 MHz | TDD |

Table 3 lists examples of FR1 bands in the 3GPP standard. We refer to the FR1 bands in the 3GPP standard, unlicensed 2.4 GHz and 5 GHz bands, 5.925-6.425 GHz and 6.425-7.125 GHz bands and any other spectrum band below 7 GHz as sub-7 GHz spectrum. The duplexing schemes used in the sub-7 GHz spectrum, among others, can be time division duplexing (TDD), frequency division duplexing (FDD), supplemental downlink (SDL) or supplemental uplink (SUL).

TABLE 3
Examples of FR1 bands in 3GPP

| 5G-NR | | | |
|---|---|---|---|
| Frequency | Uplink | | Duplex |
| Band | Frequency band | Downlink Frequency band | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-2690 MHz | FDD |
| n8 | 880 MHz-915 MHz | 925 MHz-960 MHz | FDD |
| n20 | 832 MHz-862 MHz | 791 MHz-821 MHz | FDD |
| n28 | 703 MHz-748 MHz | 758 MHz-803 MHz | FDD |
| n38 | 2570 MHz-2620 MHz | 2570 MHz-2620 MHz | TDD |
| n41 | 2496 MHz-2690 MHz | 2496 MHz-2690 MHz | TDD |
| n50 | 1432 MHz-1517 MHz | 1432 MHz-1517 MHz | TDD |
| n51 | 1427 MHz-1432 MHz | 1427 MHz-1432 MHz | TDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n74 | 1427 MHz-1470 MHz | 1475 MHz-1518 MHz | FDD |
| n75 | N/A | 1432 MHz-1517 MHz | SDL |
| n76 | N/A | 1427 MHz-1432 MHz | SDL |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |

In addition to serving mobile devices, the next generation of wireless WAN systems using millimeter wave and sub-7 GHz spectrum are expected to provide high-speed (Gigabits per second) links to fixed wireless broadband routers installed in homes and commercial buildings.

The Fourth Generation Long Term Evolution (4G LTE) system and local area network (LAN) standard called Wi-Fi use orthogonal frequency-division multiplexing (OFDM) for encoding digital data on multiple carrier frequencies. A large number of closely spaced orthogonal sub-carriers are modulated with conventional modulation schemes such as BPSK, QPSK, 16-QAM, 64-QAM and 256-QAM. The next generation of wireless WAN standard referred to as 5G New Radio (NR) also uses orthogonal frequency-division multiplexing (OFDM).

### SUMMARY

Various aspects of the present disclosure are directed to methods for wireless communication by data multiplexing using dual frequency asymmetric time division duplex (TDD). In one aspect of the present disclosure, a method includes transmitting first downlink data by a radio base station during a first time division duplex (TDD) downlink time period on a first frequency band and receiving first uplink data by the radio base station during a first time division duplex (TDD) uplink time period on the first frequency band, wherein the first downlink data and the first uplink data on the first frequency band are multiplexed using an asymmetric TDD, and wherein the first TDD downlink time period is greater than the first TDD uplink time period. The method further includes transmitting second downlink data by the radio base station during a second TDD downlink time period on a second frequency band and receiving second uplink data by the radio base station during a second TDD uplink time period on the second frequency band, wherein the second downlink data and the second uplink data on the second frequency band are multiplexed using an asymmetric TDD, and wherein the second TDD downlink time period is smaller than the second TDD uplink time period.

In an additional aspect of the disclosure, the first TDD downlink time period and the second TDD uplink time period are concurrent and have an equal length, and the first TDD uplink time period and the second TDD downlink time period are concurrent and have an equal length. In an additional aspect of the disclosure, the first TDD downlink time period and the second TDD uplink time period are non-concurrent, and the first TDD uplink time period and the second TDD downlink time period are non-concurrent.

In some embodiments, the radio base station is a gNodeB radio base station. The downlink data is received by a user equipment (UE), and the uplink data is transmitted by a user equipment (UE). In some embodiments, the first frequency band is in a millimeter wave frequency band, and in other embodiments the first frequency band is in a sub-7 GHz band. In other embodiments, the second frequency band is in a millimeter wave frequency band, and in yet other embodiments, the second frequency band is in a sub-7 GHz band. In some embodiments, the first frequency band is separated from the second frequency band by at least 2 GHz.

In an additional aspect of the disclosure, a method for wireless communication by data multiplexing using dual frequency asymmetric time division duplex includes transmitting first downlink data by a radio base station during a first time division duplex (TDD) downlink time period on a first frequency band and receiving first uplink data by the radio base station during a first TDD uplink time period on the first frequency band, wherein the first TDD downlink time period is greater than the first TDD uplink time period. The method further includes transmitting second downlink data by the radio base station during a second TDD downlink time period on a second frequency band and receiving second uplink data by the radio base station during a second TDD uplink time period on the second frequency band, wherein the second TDD uplink time period is greater than the second TDD downlink time period, and wherein the first TDD downlink time period and the second TDD uplink time period have an equal length, and wherein the first TDD uplink time period and the second TDD downlink time period have an equal length.

In an additional aspect of the disclosure, the first TDD downlink time period and the second TDD uplink time period at least partially overlap in time, and the first TDD uplink time period and the second TDD downlink time period at least partially overlap in time.

In an additional aspect of the disclosure, a method for wireless communication by data multiplexing using dual frequency asymmetric time division duplex includes transmitting at least one downlink data packet by a radio base station during a first asymmetric time division duplex (TDD) downlink time period and receiving, by the radio base station at least one uplink acknowledgement (ACK) packet during a second TDD uplink time period, wherein the uplink ACK packets are received responsive to respective downlink data packets. The method further includes receiving at least one uplink data packet by the radio base station during a first TDD uplink time period and transmitting, by the radio base station, at least one downlink ACK packet on the second frequency band during a second TDD downlink time period, wherein the downlink ACK packets are transmitted responsive to respective uplink data packets.

In some embodiments, the first TDD downlink time period is greater than the first TDD uplink time period, and the second TDD uplink time period is greater than the second TDD downlink time period. In other embodiments, the first TDD downlink time period and the second TDD uplink time period have an equal length, and wherein the first TDD uplink time period and the second TDD downlink time period have an equal length. The downlink data packets are transmitted by the radio base station in respective transmission time intervals (TTIs) during the first TDD downlink time period, and the uplink ACK packets are received by the radio base station in respective TTIs during the second TDD uplink time period. The uplink data packets are received by the radio base station in respective transmission time intervals (TTIs) during the second TDD uplink time period, and the downlink ACK packets are transmitted by the radio base station in respective TTIs during the second TDD downlink time period.

In an additional aspect of the disclosure, a method for wireless communication by data multiplexing using dual frequency asymmetric time division duplex includes receiving first downlink data by a user equipment (UE) during a first TDD downlink time period on a first frequency band and transmitting first uplink data by the UE during a first TDD uplink time period on the first frequency band, wherein the first TDD downlink time period is greater than the first TDD uplink time period. The method further includes receiving second downlink data by the UE during a second TDD downlink time period on a second frequency band and transmitting second uplink data by the UE during a second TDD uplink time period on the second frequency band, wherein the second TDD downlink time period is greater than the second TDD uplink time period. The first TDD downlink time period and the second TDD uplink time period are concurrent and have an equal length, and wherein the first TDD uplink time period and the second TDD downlink time period are concurrent and have an equal length.

In an additional aspect of the disclosure, a method for wireless communication by data multiplexing using dual frequency asymmetric time division duplex includes receiving first downlink data by a user equipment (UE) during a first time division duplex (TDD) downlink time period on a first frequency band and transmitting first uplink data by the UE during a first TDD uplink time period on the first frequency band, wherein the first TDD downlink time period is greater than the first TDD uplink time period. The method further includes receiving second downlink data by the UE during a second TDD downlink time period on a second frequency band and transmitting second uplink data by the UE during a second TDD uplink time period on the second frequency band, wherein the second TDD downlink time period is greater than the second TDD uplink time period. The first TDD downlink time period and the second TDD uplink time period have an equal length, and wherein the first TDD uplink time period and the second TDD downlink time period have an equal length. In some embodiments, the first TDD downlink time period and the second TDD uplink time period at least partially overlap in time, and the first TDD uplink time period and the second TDD downlink time period at least partially overlap in time.

In an additional aspect of the disclosure, a method for wireless communication by data multiplexing using dual frequency asymmetric time division duplex includes receiving at least one downlink data packet by a user equipment (UE) on a first frequency band during a first time division duplex (TDD) downlink time period and transmitting by the UE at least one uplink acknowledgement (ACK) packet using the first TDD on a second frequency band during a second TDD uplink time period, wherein the uplink ACK packets are transmitted responsive to respective downlink data packets. The method further includes transmitting at least one uplink data packet by the UE on the first frequency band during a first TDD uplink time period and receiving by the UE at least one downlink ACK packet on the second frequency band during a second TDD downlink time period, wherein the downlink ACK packets are transmitted responsive to respective uplink data packets. The first TDD downlink time period is greater than the first TDD uplink time period, and wherein the second TDD uplink time period is greater than the second TDD downlink time period. In some embodiments, the first TDD downlink time period and the second TDD uplink time period have an equal length, and wherein the first TDD uplink time period and the second TDD downlink time period have an equal length.

### BRIEF DESCRIPTION OF THE DRAWINGS

FIG. 1A illustrates a wireless communication system in accordance with disclosed embodiments.

FIG. 1B illustrates radio base stations communicating with communication devices using a dual frequency asymmetric time division duplexing (TDD) in accordance with some disclosed embodiments.

FIGS. 2A-2D illustrate a radio base station and a communication device communicating in a dual frequency asymmetric time division duplexing (TDD) configuration in accordance with some disclosed embodiment.

FIG. 3 is a functional block diagram of a radio base station and a communication device according to one aspect of the present disclosure.

FIGS. 4A-4B are block diagrams conceptually illustrating designs of a transceiver according to aspects of the present disclosure.

FIG. 5 illustrates uplink and downlink physical channels and uplink physical signals transmission and reception according to one aspect of the present disclosure.

### DETAILED DESCRIPTION

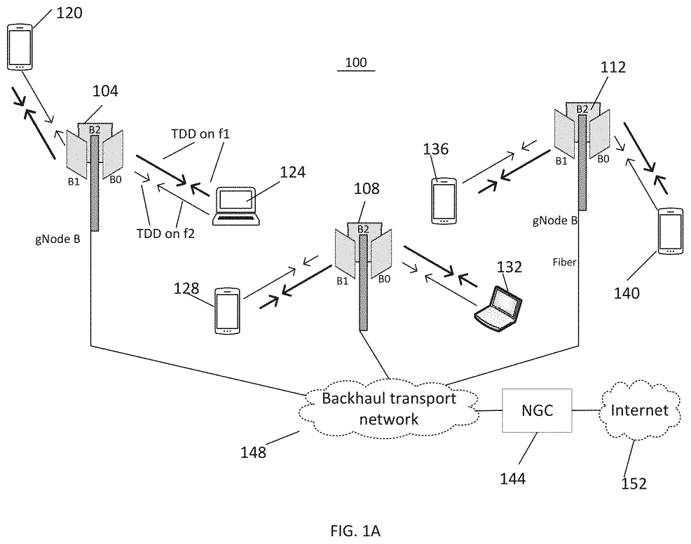

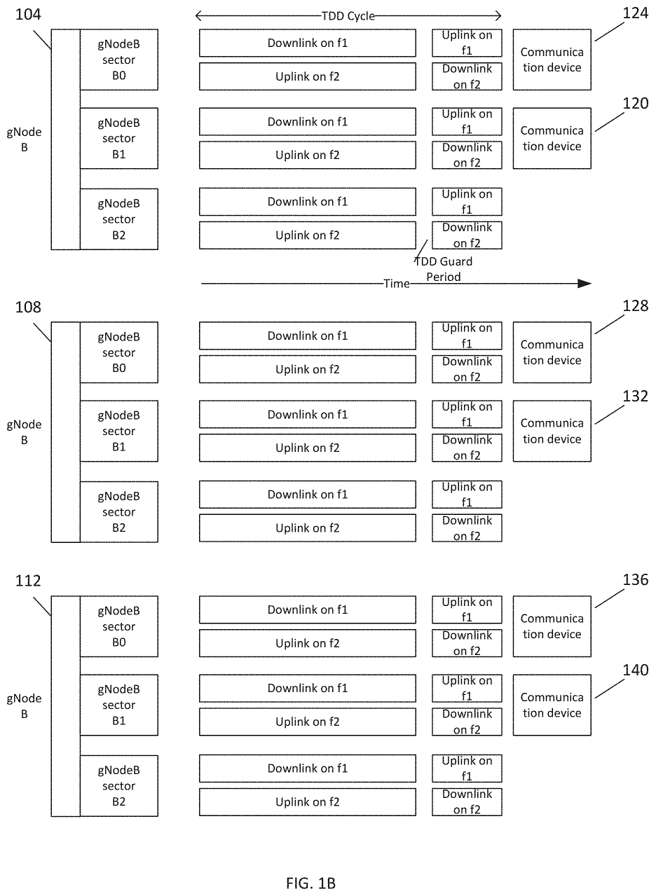

FIG. 1A illustrates a wireless communication system 100 in accordance with disclosed embodiments. The wireless system 100 uses data multiplexing using dual frequency asymmetric time division duplexing (TDD). The system 100 uses a first asymmetric time division duplexing (TDD) configuration on frequency band f1 and a second asymmetric time division duplexing (TDD) configuration on frequency band f2. The frequency band f1 can be in the millimeter wave spectrum above 24 GHz or in the sub-7 GHz spectrum. The frequency band f2 can also be in the millimeter wave spectrum above 24 GHz or in the sub-7 GHz spectrum.

In accordance with the dual frequency asymmetric TDD, on frequency band f1 in the millimeter wave spectrum above 24 GHz or in the sub-7 GHz spectrum the wireless system 100 uses a downlink-heavy TDD configuration where downlink periods for communication from the base station to the devices are longer compared to the uplink periods for communication from the devices to the base station. On frequency band f2 in the millimeter wave spectrum above 24 GHz or in the sub-7 GHz spectrum the wireless system 100 uses an uplink-heavy TDD configuration where the uplink periods for communication from the devices to the base station are longer compared to the downlink periods for communication from the base station to the devices.

Referring to FIG. 1A, the wireless system 100 includes radio base stations 104, 108 and 112 (also referred to as gNode Bs) that communicate with communication devices 120, 124, 128, 132, 136 and 140 on either millimeter wave spectrum frequency or sub-7 GHz spectrum frequency or both millimeter wave spectrum frequency and sub-7 GHz spectrum frequency. The radio base stations gNode Bs 104, 108 and 112 are connected to a network 144 (e.g., Next Generation Core (NGC) network) using a backhaul transport network 148 (e.g., high-speed Fiber backhaul & Ethernet switches). The network 144 may be connected to the Internet 152. The radio base station 104 serves communication devices 120 and 124, the radio base station 108 serves communication devices 128 and 132, and the radio base station 112 serves communication devices 136 and 140. The communication devices may, for example, be smartphones, laptop computers, desktop computers, augmented reality/virtual reality (AR/VR) devices or any other communication devices.

Referring to FIG. 1B, the radio base stations gNodeBs 104, 108 and 112 communicate with communication devices 120, 124, 128, 132, 136 and 140 using a first asymmetric time division duplexing (TDD) configuration on frequency band f1 and a second asymmetric time division duplexing (TDD) configuration on frequency band f2. In the asymmetric TDD configuration on frequency band f1, the gNodeBs 104, 108 and 112 and communication devices 120, 124, 128, 132, 136 and 140 use a downlink-heavy TDD configuration where downlink periods for communication from the base station to the devices are longer compared to the uplink periods for communication from the devices to the base station, while on frequency band f2, the gNodeBs 104, 108 and 112 and communication devices 120, 124, 128, 132, 136 and 140 use an uplink-heavy TDD configuration where the uplink periods for communication from the devices to the base station are longer compared to the downlink periods for communication from the base station to the devices. Also, the downlink periods on frequency band f1 and the uplink periods on frequency band f2 are synchronized and are of the same length. Similarly, the downlink periods on frequency band f2 and the uplink periods on frequency band f1 are synchronized and are of the same length.

Using this arrangement, the gNodeBs 104, 108 and 112 and the communication devices 120, 124, 128, 132, 136 and 140 can continually transmit and receive signals without any disruption increasing system capacity and performance while making maximum use of both the transmit and receive hardware and software resources. For example, when sector BO of base station gNodeB 104 is transmitting signals in the downlink on frequency band f1, it is also receiving signals from the communication device 124 in the uplink periods on frequency band f2. Similarly, when communication device 124 is receiving signals in the downlink on frequency band f1 from the sector BO of base station gNodeB 104, it is also transmitting signals towards the sector BO of base station gNodeB 104 in the uplink on frequency band f2. When sector BO of base station gNodeB 104 is transmitting signals in the downlink on frequency band f2, it is also receiving signals from the communication device 124 in the uplink periods on frequency band f1. Similarly, when communication device 124 is receiving signals in the downlink on frequency band f2 from the sector BO of base station gNodeB 104, it is also transmitting signals towards the sector BO of base station gNodeB 104 in the uplink on frequency band f1.

In some embodiments, the frequency f1 is in the millimeter wave spectrum above 24 GHz and the frequency f2 in the sub-7 GHz spectrum. In other embodiments, the frequency f2 is in the millimeter wave spectrum above 24 GHz and the frequency f1 in the sub-7 GHz spectrum.

In yet other embodiments of the dual frequency asymmetric TDD, the downlink periods on the frequency band f1 and the uplink periods on the frequency band f2 are not synchronized and are not of the same length. Thus, the downlink periods on the frequency band f1 may be longer than the uplink periods on the frequency band f2, or the uplink periods on the frequency band f2 may be longer than the downlink periods on the frequency band f1. Likewise, the downlink periods on the frequency band f2 and the uplink periods on frequency band f1 are not synchronized and are not of the same length. Thus, the downlink periods on the frequency band f2 may be longer than the uplink periods on the frequency band f1, or the uplink periods on the frequency band f1 may be longer than the downlink periods on the frequency band f2.

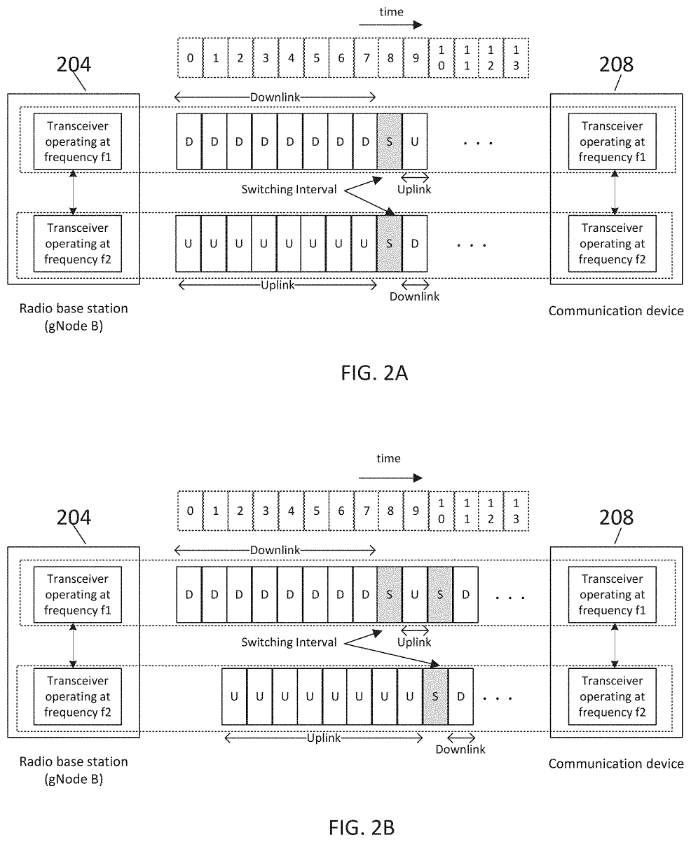

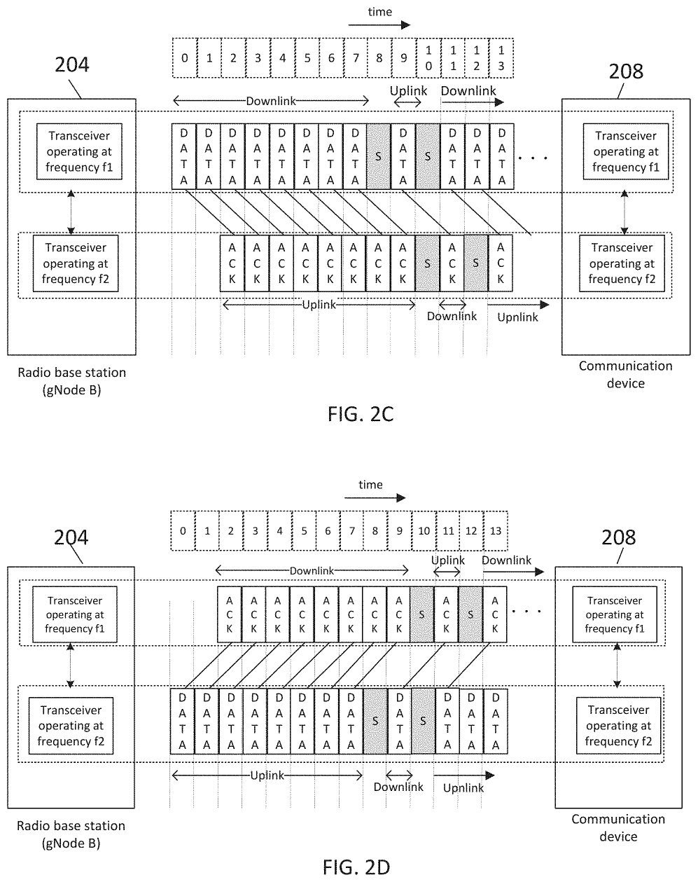

FIG. 2A illustrates a radio base station 204 and a communication device 208 communicating in a dual frequency asymmetric time division duplexing (TDD) configuration according to some disclosed embodiments. The transmission time intervals (TTIs) numbered 0 to 9 are used for communication between the base station 204 and the communication device 208 using both frequency band f1 and frequency band f2. In the frequency band f1, TTIs numbered 0 to 7 are used for downlink transmission from the base station 204 to the communication device 208, TTI numbered 8 is reserved for switching time from the downlink to uplink while a single TTI numbered 9 is used for uplink transmission from the communication device 208 to the base station 204. Thus, the system uses a downlink-heavy TDD configuration in frequency band f1 where downlink periods for communication from the base station to the devices are longer compared to the uplink periods for communication from the devices to the base station. In the frequency band f2, the system uses an uplink-heavy TDD configuration where TTIs numbered 0 to 7 are used for uplink communication from the communication device 208 to the base station 204, one of the TTIs numbered 8 is reserved for switching time from the uplink to downlink while a single TTI numbered 9 is used for downlink communication from the base station 204 to the communication device 208.

FIG. 2B illustrates a radio base station 204 and a communication device 208 communicating in a dual frequency asymmetric time division duplexing (TDD) configuration where some overlap is allowed between downlink transmissions on frequency band f1 and downlink transmissions on frequency band f2, between uplink transmissions on frequency band f1 and uplink transmissions on frequency band f2 according to some disclosed embodiments. The transmission time intervals (TTIs) numbered 0 to 11 are used for communication between the base station 204 and the communication device 208 using frequency band f1. In the frequency band f1, TTIs numbered 0 to 7 are used for downlink communication from the base station 204 to the communication device 208, one of the TTIs numbered 8 is reserved for switching time from the downlink to uplink while a single TTI numbered 9 is used for uplink communication from the communication device 208 to the base station 204. Thus, the system uses a downlink-heavy TDD configuration in frequency band f1 where downlink periods for communication from the base station to the devices are longer compared to the uplink periods for communication from the devices to the base station. In the frequency band f2, the system uses an uplink-heavy TDD configuration where TTIs numbered 2 to 9 are used for uplink communication from the communication device 208 to the base station 204, one of the TTIs numbered 10 is reserved for switching time from the uplink to downlink while a single TTI numbered 11 is used for downlink communication from the base station 204 to the communication device 208. We note that uplink transmissions on frequency band f1 and uplink transmissions on frequency band f2 overlap in the TTI numbered 9 while downlink transmissions on frequency band f1 and downlink transmissions on frequency band f2 overlap in the TTI numbered 11.

FIG. 2C illustrates a radio base station 204 and a communication device 208 communicating in a dual asymmetric time division duplexing (TDD) configuration according to the disclosed embodiment. In the embodiment of FIG. 2C, a frequency band f1 is used for uplink and downlink data packet communication, while a frequency band f2 is used for acknowledgment (ACK) of packet communication. Thus, for example, the radio base station gNodeB 204 may send a data packet on the frequency band f1 which is received by the communication device 208, and in response the communication device 208 sends an ACK packet on the frequency band f2. Similarly, the communication device 208 may send a data packet on the frequency band f1 which is received by the radio base station gNodeB 204, and in response the radio base station gNodeB 204 may send an ACK packet on the frequency band f2.

Referring to FIG. 2C, in the transmission time interval (TTI) numbered 0, the radio base station gNodeB 204 sends a data packet to the communication device 208 in the downlink on frequency f1. The communication device 208 sends an acknowledgment (ACK) in TTI numbered 2 at frequency f2 in the uplink for the data packet received from the radio base station gNodeB 204 in TTI numbered 0 on frequency f1. The communication device 208 sends an acknowledgment (ACK) in TTI numbered 3 at frequency f2 in the uplink for the data packet received from the radio base station gNodeB 204 in TTI numbered 1 on frequency f1. The communication device 208 sends an acknowledgment (ACK) in TTI numbered 4 at frequency f2 in the uplink for the data packet received from the radio base station gNodeB 204 in TTI numbered 2 on frequency f1. The communication device 208 sends an acknowledgment (ACK) in TTI numbered 5 at frequency f2 in the uplink for the data packet received from the radio base station gNodeB 204 in TTI numbered 3 on frequency f 1. The communication device 208 sends an acknowledgment (ACK) in TTI numbered 6 at frequency f2 in the uplink for the data packet received from the radio base station gNodeB 204 in TTI numbered 4 on frequency f1. The communication device 208 sends an acknowledgment (ACK) in TTI numbered 7 at frequency f2 in the uplink for the data packet received from the radio base station gNodeB 204 in TTI numbered 5 on frequency f1. The communication device 208 sends an acknowledgment (ACK) in TTI numbered 8 at frequency f2 in the uplink for the data packet received from the radio base station gNodeB 204 in TTI numbered 6 on frequency f1. The communication device 208 sends an acknowledgment (ACK) in TTI numbered 9 at frequency f2 in the uplink for the data packet received from the radio base station gNodeB 204 in TTI numbered 7 on frequency f1.

In the transmission time interval (TTI) numbered 9, the communication device 208 sends a data packet to the radio base station gNodeB 204 in the uplink on frequency f1. The radio base station gNodeB 204 sends an acknowledgment (ACK) in TTI numbered 11 at frequency f2 in the downlink for the data packet received from the communication device 208 in TTI numbered 9 on frequency f1.

FIG. 2D illustrates yet another embodiment of the dual frequency asymmetric TDD. In the embodiment of FIG. 2D, a frequency band f1 is used for uplink and downlink data ACK packet communication, while a frequency band f2 is used for data packet communication in the uplink and the downlink.

Referring to FIG. 2D, in the transmission time interval (TTI) numbered 0, the communication device 208 sends a data packet to the gNodeB 204 in the uplink on frequency f2. The gNodeB 204 sends an acknowledgment (ACK) in TTI numbered 2 at frequency f1 in the downlink for the data packet received from the communication device 208 in TTI numbered 0 on frequency f2. The gNodeB 204 sends an acknowledgment (ACK) in TTI numbered 3 at frequency f1 in the downlink for the data packet received from the communication device 208 in TTI numbered 1 on frequency f2. The gNodeB 204 sends an acknowledgment (ACK) in TTI numbered 4 at frequency f1 in the downlink for the data packet received from the communication device 208 in TTI numbered 2 on frequency f2. The gNodeB 204 sends an acknowledgment (ACK) in TTI numbered 5 at frequency f1 in the downlink for the data packet received from the communication device 208 in TTI numbered 3 on frequency f2. The gNodeB 204 sends an acknowledgment (ACK) in TTI numbered 6 at frequency f1 in the downlink for the data packet received from the communication device 208 in TTI numbered 4 on frequency f2. The gNodeB 204 sends an acknowledgment (ACK) in TTI numbered 7 at frequency f1 in the downlink for the data packet received from the communication device 208 in TTI numbered 5 on frequency f2. The gNodeB 204 sends an acknowledgment (ACK) in TTI numbered 8 at frequency f1 in the downlink for the data packet received from the communication device 208 in TTI numbered 6 on frequency f2. The gNodeB 204 sends an acknowledgment (ACK) in TTI numbered 9 at frequency f1 in the downlink for the data packet received from the communication device 208 in TTI numbered 7 on frequency f2.

In the transmission time interval (TTI) numbered 9, the radio base station gNodeB 204 sends a data packet to the communication device 208 in the downlink on frequency f2. The communication device 208 sends an acknowledgment (ACK) in TTI numbered 11 at frequency f1 in the uplink for the data packet received from the radio base station gNodeB 204 in TTI numbered 9 on frequency f2.

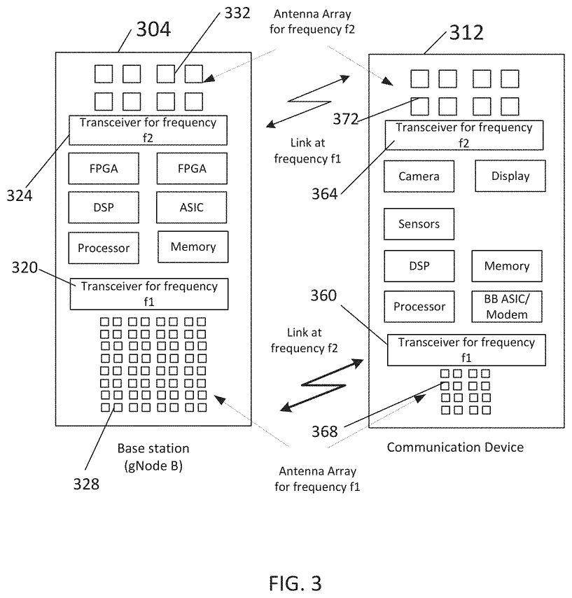

FIG. 3 is a functional block diagram of a radio base station gNodeB 304 and communication device 312 in accordance with some disclosed embodiments. The radio base station 304 includes a transceiver 320 operating at frequency f1 for signal transmissions and receptions to and from the communication device 312. The radio base station gNodeB 304 also includes a transceiver 324 operating at frequency f2 for transmitting and receiving signals to and from the communication device 312 over the frequency f2 spectrum. The radio base station gNodeB 304 further includes an antenna array 328 for operation at frequency f1 for signal transmission and reception over the frequency f1 and an antenna array 332 for operation at frequency f2 for signal transmission and reception over the frequency f2. The radio base station gNodeB 304 also includes one or more FPGAs (Field Programmable Gate Arrays), a baseband ASIC, a digital signal processor (DSP), a communications protocol processor, a memory, and networking and routing modules.

The communication device 312 includes a transceiver 360 for transmitting and receiving signals at frequency f1 to and from the radio base station 304 and a transceiver 364 for transmitting and receiving signals at frequency f2 spectrum to and from the radio base station 304. The communication device 312 also includes an antenna array 368 for operation at frequency f1 for signal transmission and reception over the frequency f1 and an antenna array 372 for operation at frequency f2 for signal transmission and reception over the frequency f2. The communication device 308 further includes a baseband ASIC/modem, a digital signal processor (DSP), a communications protocol processor, a memory and networking components. The communication device 308 may also include additional functionalities such as various sensors, a display and a camera.

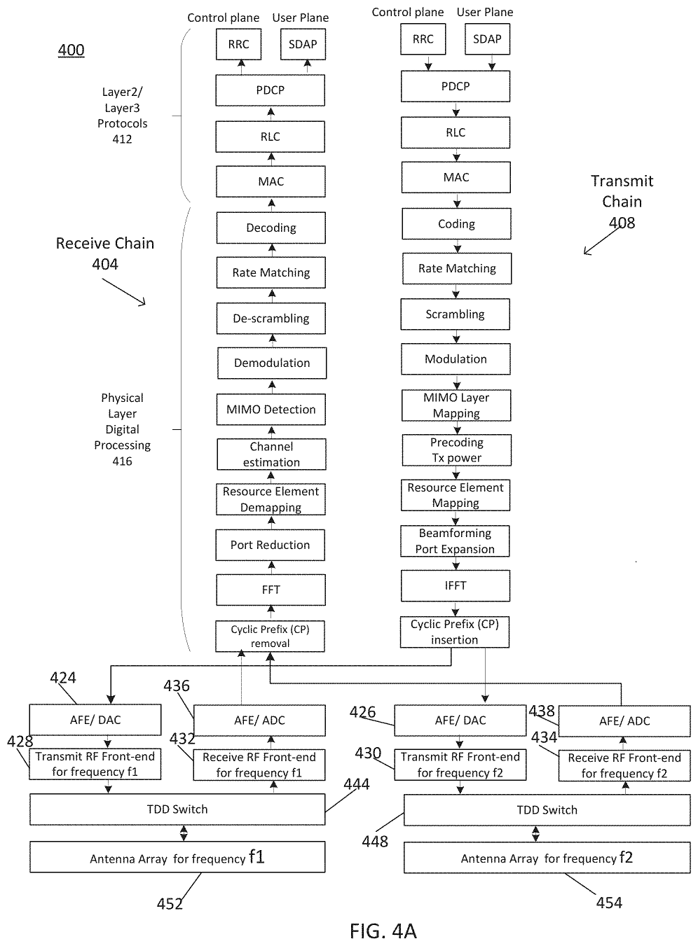

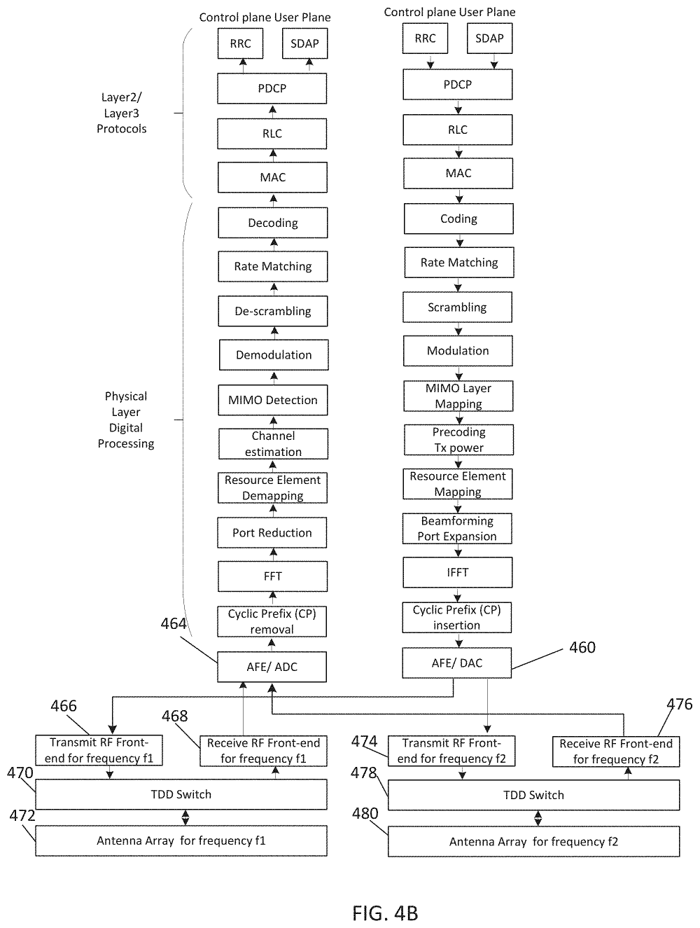

FIG. 4A is a block diagram conceptually illustrating a design of a transceiver 400 configured according to one aspect of the present disclosure. The transceiver 400 may be one of the radio base stations gNodeBs or one of the user equipment (UEs). The transceiver 400 multiplexes data and control information using the disclosed dual frequency asymmetric time division duplexing (TDD) configuration on frequency band f1 and frequency band f2.

Referring to FIG. 4A, the transceiver 400 includes a receive chain 404 (indicated by arrows pointing upward) and a transmit chain 408 (indicated by arrows pointing downward). The receive chain 404 and the transmit chain 408 each includes layer 2 and layer 3 protocols 412 comprising a Medium Access Control (MAC) layer, a Radio Link Control (RLC) layer, a Packet Data Convergence Protocol (PDCP) layer, a Service Data Adaptation Protocol (SDAP) layer and a Radio Resource Control (RRC) on top of the PDCP layer.

The main services and functions of the RRC layer include broadcast of system information, paging, security functions including key management, QoS management functions, UE measurement reporting and control of the reporting, Detection of and recovery from radio link failure and NAS (Non-Access Stratum) message transfer to/from NAS from/to UE. RRC also controls the establishment, configuration, maintenance and release of Signaling Radio Bearers (SRBs) and Data Radio Bearers (DRBs); mobility functions including handover, context transfer, UE cell selection and reselection and control of cell selection and reselection.

The main services and functions of SDAP layer include mapping between a QoS flow and a data radio bearer and marking QoS flow ID (QFI) in both downlink and uplink packets. The main services and functions of the PDCP layer include: sequence numbering, header compression, header decompression, reordering, duplicate detection, retransmission of PDCP SDUs (Service Data Units), ciphering, deciphering, integrity protection, PDCP SDU discard, duplication of PDCP PDUs (Protocol Data Units), PDCP re-establishment and PDCP data recovery for RLC AM (Acknowledged Mode).

The RLC layer supports three transmission modes: Transparent Mode (TM), Unacknowledged Mode (UM) and Acknowledged Mode (AM). The main services and functions of the RLC layer depend on the transmission mode and include: transfer of upper layer PDUs, sequence numbering independent of the one in PDCP (UM and AM), error Correction through ARQ (AM only), segmentation (AM and UM) and re-segmentation (AM only) of RLC SDUs, reassembly of SDU (AM and UM), duplicate detection (AM only), RLC SDU discard (AM and UM), RLC re-establishment and protocol error detection (AM only).

The main services and functions of the MAC layer include: mapping between logical channels and transport channels, multiplexing/demultiplexing of MAC SDUs into/from transport blocks (TB) delivered to/from the physical layer, padding, scheduling information reporting, error correction through Hybrid ARQ, priority handling between UEs by means of dynamic scheduling and priority handling between logical channels.

Referring to FIG. 4A, the receive chain 404 and the transmit chain 408 each includes a physical layer 416. The main services and functions of the physical layer 416 in the transmit direction (i.e., in transmit chain 408) include: channel coding, scrambling, physical-layer hybrid-ARQ processing, rate matching, bit-interleaving, modulation (QPSK, 16QAM, 64QAM and 256QAM etc.), MIMO layer mapping, MIMO pre-coding and mapping of symbols to assigned resources and antenna ports. The physical layer in the transmit chain 408 also implements OFDM (Orthogonal Frequency Division Multiplexing) processing that includes IFFT (Inverse Fast Fourier Transform) functions as well as addition of cyclic prefix (CP).

In the receive chain 404, the physical layer implements OFDM (Orthogonal Frequency Division Multiplexing) processing that includes FFT (Fast Fourier Transform) functions, removal of cyclic prefix (CP), port reduction, resource element de-mapping, channel estimation, MIMO detection, demodulation (QPSK, 16QAM, 64QAM and 256QAM etc.), descrambling, physical-layer hybrid-ARQ processing, rate matching, bit-de-interleaving and channel decoding etc.

In some embodiments of the present disclosure, the physical layer functions are generally implemented in FPGAs (Field Programmable Gate Arrays), baseband ASIC, or digital signal processor (DSP). Consequently, the hardware resources are tied to either the transmit physical layer processing or the receive physical layer processing.

In existing conventional TDD systems, a radio base station gNodeB or a communication device is either in a transmit mode or in a receive mode. In a transmit mode, only transmit physical layer functions of existing conventional TDD systems are used, and when in a receive mode, only receive physical layer functions of existing conventional TDD systems are used, which results in inefficient utilization of FPGAs, baseband ASIC, or digital signal processor (DSP) resources.

The embodiments of the present disclosure provide an advantage over the existing conventional TDD systems by allowing more efficient utilization of FPGAs, baseband ASIC, or digital signal processor (DSP) resources. According to the dual frequency asymmetric TDD, both a radio base station gNodeB and communication devices can simultaneously operate in transmit and receive modes. For example, when the radio base station gNodeB is in a transmit mode on frequency band f1, it also is in a receive mode on frequency band f2. Similarly, when the communication devices are in a transmit mode on frequency band f2, they are also in a receive mode on frequency band f1. Thus, the embodiments of the present disclosure provide an efficient utilization of the FPGA, baseband ASIC, or digital signal processor (DSP) resources.

Referring to FIG. 4A, the transmit chain 408 includes Analog Front End (AFE) modules 424 and 426 for frequency f1 and frequency f2, respectively. The Analog Front End (AFE) modules 424 and 426 in the transmit chain 408 generally include a digital up-conversion stage and a digital to analog conversion (DAC) stage. A Digital up converter (DUC) converts a baseband low sampling rate signal to a high sampling rate IF (intermediate frequency) signal by first up-sampling the baseband signal to the required sampling frequency and then mixing it with the high frequency carrier.

The transmit chain 408 also includes RF front-ends 428 and 430 for frequency f1 and for frequency f2, respectively. The receive chain 404 includes RF front-end modules 432 and 434 for frequency f1 and for frequency f2, respectively. A transmit RF front-end module generally includes an analog up-conversion stage which can be implemented by using a frequency mixer driven by a Local Oscillator (LO), a filtering stage and one or more amplification stages using pre-power amplifiers (PPA) and power amplifiers (PA). A receive RF front-end module generally includes one or more amplification stages using low-noise-amplifiers (LNAs), a filtering stage and an analog down-conversion stage which can be implemented by using a frequency mixer driven by a Local Oscillator (LO). In some implementations, analog up-conversion stage analog down-conversion stage can be driven by the same Local Oscillator (LO).

The receive chain 404 also includes Analog Front End (AFE) modules 436 and 438 for frequency f1 and frequency f2, respectively. A receive Analog Front End (AFE) module generally includes an analog-to-digital conversion (ADC) stage and a digital down conversion (DCC) stage. The DDC converts the signal at the output of analog to digital convertor (ADC), centered at the intermediate frequency (IF), to complex baseband signal. In addition, DDC also decimates the baseband signal without affecting its spectral characteristics. In some implementations, the transmit Analog Front End (AFE) module and receive Analog Front End (AFE) module can be implemented in a single integrated circuit (IC).

Referring to FIG. 4A, the transceiver 400 includes a TDD switch 444 to switch between the transmit and receive time intervals on frequency f1 and a TDD switch 448 to switch between the transmit and receive time intervals on frequency f2. The transceiver 400 also includes an antenna array 452 for frequency f1 and an antenna array 454 for frequency f2. In some embodiments, the TDD switch 444 and the TDD switch 448 are controlled by the Medium Access Control (MAC) layer that is responsible for scheduling the downlink and uplink transmissions.

In operation, when the transceiver 400 transmits on frequency f1 and at the same time receives on frequency f2, the TDD switch 444 connects the transmit chain 408 to the antenna array 452 and disconnects the receive chain 404 from the antenna array 452, and the TDD switch 448 connects the receive chain 404 to the antenna array 454 and disconnects the transmit chain 408 from the antenna array 454. When the transceiver 400 receives on frequency f1 and at the same time transmits on frequency f2, the TDD switch 444 disconnects the transmit chain 408 from the antenna array 452 and connects the receive chain 404 to the antenna array 452, and the TDD switch 448 disconnects the receive chain 404 from the antenna array 454 and connects the transmit chain 408 to the antenna array 454.

In the embodiment of FIG. 4A, the physical layers in the transmit chain 408 and the receive chain 404 and Layer 2 and Layer 3 are shared between frequency f1 and frequency f2 because when the radio base station gNodeB is in a transmit mode on frequency band f1, it is in a receive mode on frequency band f2. Also, when the communication devices are in a transmit mode on frequency band f2, they are also in a receive mode on frequency band f1.

In yet another embodiment of the present disclosure illustrated in FIG. 4B, Analog Front End (AFE)/Digital-to-Analog Conversion (DAC) module 460 and Analog Front End (AFE)/Analog-to-Digital Conversion (DAC) module 464 are shared between frequency f1 and frequency f2. However, a transmit RF Front-end 466, a receive RF Front-end 468, a TDD switch 470 and an antenna array 472 are provided for frequency f1. Similarly, a transmit RF Front-end 474, a receive RF Front-end 476, a TDD switch 478 and an antenna array 480 are provided for frequency f2.

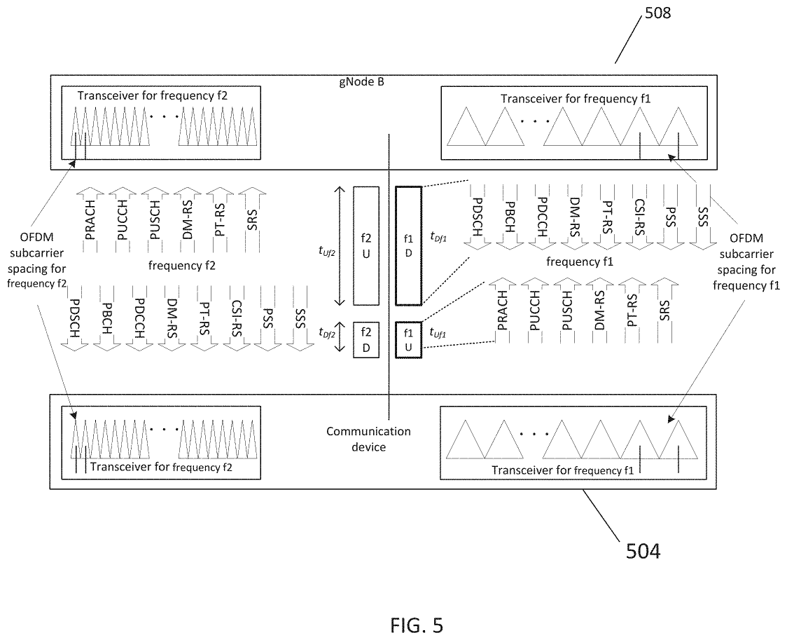

FIG. 5 illustrates uplink physical channels and uplink physical signals transmission and reception, and downlink physical channels and downlink physical signals transmission and reception according to some disclosed embodiments. An uplink physical channel corresponds to a set of resource elements carrying information originating from higher layers. The uplink physical channels transmitted from a communication device 504 and received by a radio base station 508 include: Physical Uplink Shared Channel (PUSCH), Physical Uplink Control Channel (PUCCH), Physical Random Access Channel (PRACH). An uplink physical signal is used by the physical layer but does not carry information originating from higher layers. The uplink physical signals transmitted from the communication device 504 and received by the radio base station 508 on include: Demodulation reference signals (DM-RS), Phase-tracking reference signals (PT-RS) and Sounding reference signal (SRS). The TDD transmission interval for transmission of uplink physical channels and uplink physical signals by the communication devices on frequency f1 denoted as t_{Uf1} is smaller compared to TDD transmission interval for transmission of uplink physical channels and uplink physical signals by the communication devices on frequency f2 denoted as t_{Uf2}, that is, t_{Uf1}<t_{Uf2}.

A downlink physical channel corresponds to a set of resource elements carrying information originating from higher layers. The downlink physical channels transmitted from the radio base station 508 and received by the communication device 504 include: Physical Downlink Shared Channel (PDSCH), Physical Broadcast Channel (PBCH) and Physical Downlink Control Channel (PDCCH). A downlink physical signal corresponds to a set of resource elements used by the physical layer but does not carry information originating from higher layers. The downlink physical signals transmitted from the radio base station 508 and received by the communication device 504 include: Demodulation reference signals (DM-RS), Phase-tracking reference signals (PT-RS) Channel-state information reference signal (CSI-RS) Primary synchronization signal (PSS) and Secondary synchronization signal (SSS). The TDD transmission interval for transmission of downlink physical channels and downlink physical signals by the radio base station on frequency f1 denoted as t_{Df1} is larger compared to TDD transmission interval for transmission of downlink physical channels and downlink physical signals by the radio base station on frequency f2 denoted as t_{Df2}, that is, t_{Df1}>t_{Df2}.

In some disclosed embodiments, the TDD transmission interval for transmission of downlink physical channels and downlink physical signals by the radio base station on frequency f1 denoted as t_{Df1} is set equal to the TDD transmission interval for transmission of uplink physical channels and uplink physical signals by the communication device on frequency f2 denoted as t_{Uf2}, that is, t_{Df1}=t_{Uf2}. In other words, the TDD reception interval for reception of downlink physical channels and downlink physical signals by the communication device on frequency f1 denoted as t_{Df1} is set equal to the TDD reception interval for reception of uplink physical channels and uplink physical signals by the by the radio base station on frequency f2 denoted as t_{Uf2}, that is, t_{Df1}=t_{Uf2}. The TDD transmission interval for transmission of downlink physical channels and downlink physical signals by the radio base station on frequency f2 denoted as t_{Df2} is set equal to the TDD transmission interval for transmission of uplink physical channels and uplink physical signals by the communication device on frequency f1 denoted as t_{Uf1}, that is, t_{Df2}=t_{Uf1}. In other words, the TDD reception interval for reception of downlink physical channels and downlink physical signals by the communication device on frequency f2 denoted as t_{Df2} is set equal to the TDD reception interval for reception of uplink physical channels and uplink physical signals by the by the radio base station on frequency f1 denoted as t_{Uf1}, that is, t_{Df2}=t_{Uf1}.

By using this multiplexing approach in asymmetric TDD, the radio base station 508 and the communication device 504 more efficiently utilize hardware and software resources. When the radio base station 508 is transmitting downlink physical channels and downlink physical signals on frequency f1, it is also receiving uplink physical channels and uplink physical signals on frequency f2. For example, FPGA and ASIC resources implementing channel encoding, modulation, MIMO precoding, IFFT are used by the transmitter on frequency f1 while the FPGA and ASIC resources implementing channel decoding, demodulation, MIMO detection, FFT are used by the receiver on frequency f2 as illustrated in FIG. 4A. In other embodiments, when AFE/DAC (Analog Front End/Digital-to-Analog Converter) resources are used by the transmitter on frequency f1, AFE/ADC (Analog Front End/Analog-to-Digital Converter) resources are used by the receiver on frequency f2 as illustrated in FIG. 4B.

When the radio base station 508 is transmitting downlink physical channels and downlink physical signals on frequency f2, it is also receiving uplink physical channels and uplink physical signals on frequency f1. For example, FPGA and ASIC resources implementing channel encoding, modulation, MIMO precoding, IFFT are used by the transmitter on frequency f2 while the FPGA and ASIC resources implementing channel decoding, demodulation, MIMO detection, FFT are used by the receiver on frequency f1. In other embodiments, when AFE/DAC (Analog Front End/Digital-to-Analog Converter) resources are used by the transmitter on frequency f2, AFE/ADC (Analog Front End/Analog-to-Digital Converter) resources are used by the receiver on frequency f1.

When the communication device 504 is transmitting uplink physical channels and uplink physical signals on frequency f1, it is also receiving downlink physical channels and downlink physical signals on frequency f2. For example, ASIC/modem resources implementing channel encoding, modulation, MIMO precoding, IFFT are used by the transmitter on frequency f1 while the ASIC/modem resources implementing channel decoding, demodulation, MIMO detection, FFT are used by the receiver on frequency f2. In other embodiments, when AFE/DAC (Analog Front End/Digital-to-Analog Converter) resources are used by the transmitter on frequency f1, AFE/ADC (Analog Front End/Analog-to-Digital Converter) resources are used by the receiver on frequency f2.

When the communication device 504 is transmitting uplink physical channels and uplink physical signals on frequency f2, it is also receiving downlink physical channels and downlink physical signals on frequency f1. For example, ASIC/modem resources implementing channel encoding, modulation, MIMO precoding, IFFT are used by the transmitter on frequency f2 while the ASIC/modem resources implementing channel decoding, demodulation, MIMO detection, FFT are used by the receiver on frequency f1. In other embodiments, when AFE/DAC (Analog Front End/Digital-to-Analog Converter) resources are used by the transmitter on frequency f2, AFE/ADC (Analog Front End/Analog-to-Digital Converter) resources are used by the receiver on frequency f1.

In some disclosed embodiments, baseband functions are implemented in an application-specific integrated circuit (ASIC) system-on-a-chip (SoC). In other embodiments, these functions can be implemented on general-purpose processors or in field-programmable gate array (FPGA) integrated circuits.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above in general terms of their functionality. Whether such functionality is implemented as hardware or software depends upon the particular application and design constraints imposed on the overall system Those of skill may implement the described functionality in varying ways for each particular application, but such implementation decision should not be interpreted as causing a departure from the scope of the present disclosure.

The various illustrative logical blocks, modules and circuits described in connection with the disclosure herein may be implemented or performed with a general purpose processor, a digital signal processor (DSP), an application specific integrated circuit (ASIC), a field programmable gate array (FPGA), or other programmable logic device, transistor logic, discrete hardware components, or any combination thereof designed to perform the functions described herein. A general purpose processor may be a microprocessor, a controller, a microcontroller or a state machine.

The steps of a method or algorithm described in connection with the disclosure herein may be embodied in hardware, in a software module executed by a processor or in a combination of the two. A software module may reside in RAM memory, flash memory, ROM memory, EPROM memory, registers, hard disk, a removable disk, a CD-ROM, or any other form of storage known in the art. An exemplary storage medium is coupled to the processor such that the processor can read information from, and write information to, the storage medium. In the alternative, the storage medium may be integral to the processor. The processor and the storage medium may reside in an ASIC, or the processor and the storage medium may reside in discrete components.

In one or more exemplary designs, the functions described may be implemented in hardware, software, firmware, or any combination thereof. If implemented in software, the functions may be stored on or transmitted over as one or more instructions or code on a computer-readable medium. Computer-readable medium includes both non-transitory computer storage media and communication media including any medium that facilitates transfer of a computer program from one location to another. A non-transitory storage media may be any available media that can be accessed by a general purpose or special purpose computer. By way of example, and not limitation, such non-transitory computer readable media can comprise RAM, ROM, EEPROM, CD-ROM, optical disk storage, magnetic disk storage, DVD, or any other medium that can be used to store program code means in the form of instructions or data structures and that can be accessed by a general purpose or special purpose processor. Any connection is termed a computer-readable medium. If the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk, as used herein, includes CD, laser disc, optical disc, DVD, floppy disk and other disks that reproduce data.

The previous description of disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and features disclosed herein.

1. A method for wireless communication by data multiplexing using dual frequency asymmetric time division duplex, comprising:
transmitting first downlink data by a radio base station during a first time division duplex (TDD) downlink time period on a first frequency band;
receiving first uplink data by the radio base station during a first time division duplex (TDD) uplink time period on the first frequency band,
wherein the first downlink data and the first uplink data on the first frequency band are multiplexed using an asymmetric TDD, and wherein the first TDD downlink time period is greater than the first TDD uplink time period;
transmitting second downlink data by the radio base station during a second TDD downlink time period on a second frequency band;
receiving second uplink data by the radio base station during a second TDD uplink time period on the second frequency band,
wherein the second downlink data and the second uplink data on the second frequency band are multiplexed using an asymmetric TDD, and wherein the second TDD downlink time period is smaller than the second TDD uplink time period.

2. The method of claim 1, wherein the first TDD downlink time period and the second TDD uplink time period are concurrent and have an equal length, and wherein the first TDD uplink time period and the second TDD downlink time period are concurrent and have an equal length.

3. The method of claim 1, wherein the first TDD downlink time period and the second TDD uplink time period are non-concurrent, and wherein the first TDD uplink time period and the second TDD downlink time period are non-concurrent.

4. The method of claim 1, wherein the radio base station is a gNodeB radio base station.

5. The method of claim 1, wherein the downlink data is received by a user equipment (UE).

6. The method of claim 1, wherein the uplink data is transmitted by a user equipment (UE).

7. The method of claim 1, wherein the first frequency band is in a millimeter wave frequency band.

8. The method of claim 1, wherein the first frequency band is in a sub-7 GHz band.

9. The method of claim 1, wherein the second frequency band is in a millimeter wave frequency band.

10. The method of claim 1, wherein the second frequency band is in a sub-7 GHz band.

11. The method of claim 1, wherein the first frequency band is separated from the second frequency band by at least 2 GHz.

12. A method for wireless communication by data multiplexing using dual frequency asymmetric time division duplex, comprising:
transmitting first downlink data by a radio base station during a first time division duplex (TDD) downlink time period on a first frequency band;
receiving first uplink data by the radio base station during a first TDD uplink time period on the first frequency band, wherein the first TDD downlink time period is greater than the first TDD uplink time period;
transmitting second downlink data by the radio base station during a second TDD downlink time period on a second frequency band;
receiving second uplink data by the radio base station during a second TDD uplink time period on the second frequency band,
wherein the second TDD uplink time period is greater than the second TDD downlink time period, and wherein the first TDD downlink time period and the second TDD uplink time period have an equal length, and wherein the first TDD uplink time period and the second TDD downlink time period have an equal length.

13. The method of claim 12, wherein the first TDD downlink time period and the second TDD uplink time period at least partially overlap in time.

14. The method of claim 12, wherein the first TDD uplink time period and the second TDD downlink time period at least partially overlap in time.

15. The method of claim 12, wherein the radio base station is a gNodeB radio base station.

16. The method of claim 12, wherein the downlink data is received by a user equipment (UE).

17. The method of claim 12, wherein the uplink data is transmitted by a user equipment (UE).

18. The method of claim 12, wherein the first frequency band is in a millimeter wave frequency band.

19. The method of claim 12, wherein the first frequency band is in a sub-7 GHz band.

20. The method of claim 12, wherein the second frequency band is in a millimeter wave frequency band.

21. The method of claim 12, wherein the second frequency band is in a sub-7 GHz band.

22. A method for wireless communication by data multiplexing using dual frequency asymmetric time division duplex, comprising:
transmitting at least one downlink data packet by a radio base station during a first asymmetric time division duplex (TDD) downlink time period;
receiving, by the radio base station at least one uplink acknowledgement (ACK) packet during a second TDD uplink time period, wherein the uplink ACK packets are received responsive to respective downlink data packets;
receiving at least one uplink data packet by the radio base station during a first TDD uplink time period;
transmitting, by the radio base station, at least one downlink ACK packet on the second frequency band during a second TDD downlink time period, wherein the downlink ACK packets are transmitted responsive to respective uplink data packets,
wherein the first TDD downlink time period is greater than the first TDD uplink time period, and wherein the second TDD uplink time period is greater than the second TDD downlink time period.

23. The method of claim 22, wherein the first TDD downlink time period and the second TDD uplink time period have an equal length, and wherein the first TDD uplink time period and the second TDD downlink time period have an equal length.

24. The method of claim 22, wherein the downlink data packets are transmitted by the radio base station in respective transmission time intervals (TTIs) during the first TDD downlink time period, and wherein the uplink ACK packets are received by the radio base station in respective TTIs during the second TDD uplink time period.

25. The method of claim 22, wherein the uplink data packets are received by the radio base station in respective transmission time intervals (TTIs) during the second TDD uplink time period, and wherein the downlink ACK packets are transmitted by the radio base station in respective TTIs during the second TDD downlink time period.

26. The method of claim 22, wherein the downlink data packet is received by a user equipment (UE).

27. The method of claim 22, wherein the uplink data is transmitted by a user equipment (UE).

28. The method of claim 22, wherein the downlink ACK packet is received by a user equipment (UE).

29. The method of claim 22, wherein the uplink ACK packet is transmitted by a user equipment (UE).

30. The method of claim 22, wherein the first frequency band is in a millimeter wave frequency band.

31. The method of claim 22, wherein the first frequency band is in a sub-7 GHz band.

32. The method of claim 22, wherein the second frequency band is in a millimeter wave frequency band.

33. The method of claim 22, wherein the second frequency band is in a sub-7 GHz band.

34. A method for wireless communication by data multiplexing using dual frequency asymmetric time division duplex, comprising:
receiving first downlink data by a user equipment (UE) during a first TDD downlink time period on a first frequency band;
transmitting first uplink data by the UE during a first TDD uplink time period on the first frequency band, wherein the first TDD downlink time period is greater than the first TDD uplink time period;
receiving second downlink data by the UE during a second TDD downlink time period on a second frequency band;
transmitting second uplink data by the UE during a second TDD uplink time period on the second frequency band, wherein the second TDD downlink time period is greater than the second TDD uplink time period,
wherein the first TDD downlink time period and the second TDD uplink time period are concurrent and have an equal length, and wherein the first TDD uplink time period and the second TDD downlink time period are concurrent and have an equal length.

35. The method of claim 34, wherein the downlink data is transmitted by a radio base station.

36. The method of claim 34, wherein the uplink data is received by a radio base station.

37. The method of claim 34, wherein the first frequency band is in a millimeter wave frequency band.

38. The method of claim 34, wherein the first frequency band is in a sub-7 GHz band.

39. The method of claim 34, wherein the second frequency band is in a millimeter wave frequency band.

40. The method of claim 34, wherein the second frequency band is in a sub-7 GHz band.

41. The method of claim 34, wherein the first frequency band is separated from the second frequency band by at least 2 GHz.

42. A method for wireless communication by data multiplexing using dual frequency asymmetric time division duplex, comprising:
receiving first downlink data by a user equipment (UE) during a first time division duplex (TDD) downlink time period on a first frequency band;
transmitting first uplink data by the UE during a first TDD uplink time period on the first frequency band, wherein the first TDD downlink time period is greater than the first TDD uplink time period;
receiving second downlink data by the UE during a second TDD downlink time period on a second frequency band;
transmitting second uplink data by the UE during a second TDD uplink time period on the second frequency band, wherein the second TDD downlink time period is greater than the second TDD uplink time period,
wherein the first TDD downlink time period and the second TDD uplink time period have an equal length, and wherein the first TDD uplink time period and the second TDD downlink time period have an equal length.

43. The method of claim 42, wherein the first TDD downlink time period and the second TDD uplink time period at least partially overlap in time.

44. The method of claim 42, wherein the first TDD uplink time period and the second TDD downlink time period at least partially overlap in time.

45. The method of claim 42, wherein the downlink data is transmitted by a radio base station.

46. The method of claim 42, wherein the uplink data is received by a radio base station.

47. The method of claim 42, wherein the first frequency band is in a millimeter wave frequency band.

48. The method of claim 42, wherein the first frequency band is in a sub-7 GHz band.

49. The method of claim 42, wherein the second frequency band is in a millimeter wave frequency band.

50. The method of claim 42, wherein the second frequency band is in a sub-7 GHz band.

51. A method for wireless communication by data multiplexing using dual frequency asymmetric time division duplex, comprising:
receiving at least one downlink data packet by a user equipment (UE) on a first frequency band during a first time division duplex (TDD) downlink time period;
transmitting by the UE at least one uplink acknowledgement (ACK) packet using the first TDD on a second frequency band during a second TDD uplink time period, wherein the uplink ACK packets are transmitted responsive to respective downlink data packets;
transmitting at least one uplink data packet by the UE on the first frequency band during a first TDD uplink time period;
receiving by the UE at least one downlink ACK packet on the second frequency band during a second TDD downlink time period, wherein the downlink ACK packets are transmitted responsive to respective uplink data packets,
wherein the first TDD downlink time period is greater than the first TDD uplink time period, and wherein the second TDD uplink time period is greater than the second TDD downlink time period.

52. The method of claim 51, wherein the first TDD downlink time period and the second TDD uplink time period have an equal length, and wherein the first TDD uplink time period and the second TDD downlink time period have an equal length.

53. The method of claim 51, wherein the downlink data packets are received by the UE using the first TDD in respective transmission time intervals (TTIs) during the first TDD downlink time period, and wherein the uplink ACK packets are transmitted by the UE using the first TDD in respective TTIs during the second TDD uplink time period.

54. The method of claim 51, wherein the uplink data packets are transmitted by the UE using the second TDD in respective transmission time intervals (TTIs) during the second TDD uplink time period, and wherein the downlink ACK packets are received by the UE using the second TDD in respective TTIs during the second TDD downlink time period.

55. The method of claim 51, wherein the first TDD downlink time period and the second TDD uplink time period at least partially overlap in time.

56. The method of claim 51, wherein the first TDD uplink time period and the second TDD downlink time period at least partially overlap in time.

57. The method of claim 51, wherein the downlink data packet is transmitted by a radio base station.

58. The method of claim 51, wherein the uplink data packet is received by a radio base station.

59. The method of claim 51, wherein the first frequency band is in a millimeter wave frequency band.

60. The method of claim 51, wherein the first frequency band is in a sub-7 GHz band.

61. The method of claim 51, wherein the second frequency band is in a millimeter wave frequency band.

62. The method of claim 51, wherein the second frequency band is in a sub-7 GHz band.
